(19) United States
(12) Patent Application Publication
(10) Pub. No.: US 2011/0261027 A1
(43) Pub. Date: Oct. 27, 2011

(54) SIGNAL TRANSMISSION DEVICE AND A DISPLAY APPARATUS HAVING THE SAME

(76) Inventor: Sang Keun Lee, Seoul (KR)

(21) Appl. No.: 12/848,651

(22) Filed: Aug. 2, 2010

(30) Foreign Application Priority Data
Apr. 26, 2010 (KR) 10-2010-0038643

(51) Int. Cl. G09G 5/00

(52) U.S. Cl. 345/204; 345/1.2

(57) ABSTRACT

A display apparatus includes a display part including a plurality of data lines to display an image, a data driver electrically connected to the data lines to apply data signals to the data lines, a controller converting an input image signal into a data format used by the data driver and transmitting the converted image signal to the data driver using a differential signaling scheme, and a filter filtering the converted image signal provided from the controller in the differential signaling scheme and passing the filtered image signal to the data driver.

### CROSS-REFERENCE TO RELATED APPLICATION

This application claims priority to Korean Patent Application No. 2010-38643 filed on Apr. 26, 2010, the disclosure of which is incorporated by reference herein in its entirety.

### BACKGROUND

1. Technical Field

The present invention relates to a signal transmission device and a display apparatus having the same. More particularly, the present invention relates to a signal transmission device capable of matching its impedance using a high-pass filter and a display apparatus having the same.

2. Discussion of the Related Art

In general, a liquid crystal display includes an upper substrate and a lower substrate. The upper substrate includes a common electrode and a color filter array and the lower substrate includes a plurality of thin film transistors and a plurality of pixel electrodes. Alignment layers are respectively coated on the upper and lower substrates and a liquid crystal layer is disposed between the alignment layers.

When voltages are applied to the pixel electrodes and the common electrode, an electric field is generated between the pixel electrodes and the common electrode, thereby changing an arrangement of liquid crystal molecules in the liquid crystal layer. As a result, a transmittance of light passing through the liquid crystal layer is changed according to the changed arrangement of the liquid crystal molecules, to thereby display a desired image.

To prevent electromagnetic interference (EMI) in signal transmission lines used to transmit data in a display apparatus, differential signaling schemes, such as a low voltage differential signaling (LVDS), a reduced swing differential signaling (RSDS), an advance intra-panel interface (AiPi), etc., have been introduced.

The LVDS uses a voltage difference between two signal transmission lines through which a positive signal and a negative signal are transmitted, respectively, so that data can be recognized even though the voltage difference between the two signal transmission lines is small. In the above-mentioned differential signaling schemes, the EMI is minimized by cancelling the electromagnetic component of the positive and negative signals. Further, data loss does not occur since the data is recognized by the difference between the positive and negative signals even if noise is present in both signals.

In general, a termination resistor is placed at an outer input terminal of a differential signal amplifying circuit to recognize the voltage difference between the positive signal and the negative signal. However, electric charges passing through a conductor move through regions close to the conductor due to an increase of frequency. Consequently, since a cross-sectional area through which current flows decreases and resistance increases, an attenuation phenomenon, called a skin effect, occurs. Due to the skin effect, the signal transmission lines serve as a low-pass filter. As a result, a high frequency component is attenuated and a signal distortion may occur at a receiver, thereby causing the data to be lost.

Accordingly, there is a need for a device that can prevent such data loss.

### SUMMARY

According to an exemplary embodiment of the present invention, a display apparatus includes a display part, a data driver, a controller, and a filter. The display part includes a plurality of data lines to display an image, and the data driver is electrically connected to the data lines to apply data signals to the data lines. The controller converts an input image signal into a data format used by the data driver and transmits the converted image signal to the data driver using a differential signaling scheme, and the filter filters the converted image signal provided from the controller in the differential signaling scheme and passes the filtered image signal to the data driver.

The differential signaling scheme is a low voltage differential signaling, a reduced swing differential signaling, or an advance intra-panel interface.

The filter comprises a high-pass filter.

The filter comprises a resistor, a capacitor, and an inductor.

The filter has an impedance matching structure.

The filter comprises a first resistor connected between a ground and a first node, a second resistor connected between the first node and a second node, a capacitor connected to the second resistor in parallel, an inductor connected to the second resistor in parallel and connected to the capacitor in series, and a third resistor connected between the second node and the ground.

According to an exemplary embodiment of the present invention, a display apparatus includes a controller, a data driver, a display part, and a filter. The controller receives a signal from an exterior and outputs an image signal in response to the received signal, and the data driver outputs a data signal in response to the image signal. The display part receives the data signal to display an image, and the filter is disposed between the controller and the data driver to filter the image signal.

The controller transmits the image signal to the data driver in a differential signaling scheme.

The data driver comprises a plurality of driver integrated circuits.

The filter comprises a plurality of sub-filters.

Each of the driver integrated circuits comprises two input terminals, wherein each input terminal is connected to a sub-filter.

Each of the sub-filters is a high-pass filter having an input impedance of about 50 ohms at a frequency that is the same as a transmission frequency of the image signal.

Each of the sub-filters comprises: a first resistor connected between an input terminal and a ground; a second resistor connected between the input terminal and an output terminal; a third resistor connected between the output terminal and the ground; a capacitor connected between the input terminal and the output terminal and connected to the second resistor in parallel; and an inductor connected between the input terminal and the output terminal and connected to the second resistor in parallel.

According to an exemplary embodiment of the present invention, a signal transmission device includes a controller that receives a signal from an exterior and outputs an image signal in response to the received signal, a data driver that receives the image signal, and a filter disposed between the controller and the data driver to filter the image signal.

The controller transmits the image signal to the data driver in a differential signaling scheme.

The data driver comprises a plurality of driver integrated circuits.

The filter comprises a plurality of sub-filters.

Each of the driver integrated circuits comprises two input terminals, each input terminal connected to a sub-filter.

Each of the sub-filters is a high-pass filter having an input impedance of about 50 ohms at a frequency that is the same as a transmission frequency of the image signal.

Each of the sub-filters comprises: a first resistor connected between an input terminal and a ground; a second resistor connected between the input terminal and an output terminal; a third resistor connected between the output terminal and the ground; a capacitor connected between the input terminal and the output terminal and connected to the second resistor in parallel; and an inductor connected between the input terminal and the output terminal and connected to the second resistor in parallel.

### BRIEF DESCRIPTION OF THE DRAWINGS

The above and other features of the present invention will become more apparent by describing in detail exemplary embodiments thereof with reference to the accompanying drawings in which:

FIG. 1 is a block diagram showing a display apparatus according to an exemplary embodiment of the present invention;

FIG. 2 is a circuit diagram showing a filter of FIG. 1 according to an exemplary embodiment of the present invention;

FIG. 3 is a graph showing a transfer voltage ratio of a sub-filter of FIG. 2 as a function of frequency according to an exemplary embodiment of the present invention; and

FIG. 4 is a graph showing an input impedance of a sub-filter of FIG. 2 as a function of frequency according to an exemplary embodiment of the present invention.

### DETAILED DESCRIPTION OF EXEMPLARY EMBODIMENTS

Exemplary embodiments of the present invention will be described more fully hereinafter with reference to the accompanying drawings. However, the present invention may be embodied in various different ways and should not be construed as limited to the exemplary embodiments described herein.

It will be understood that when an element or layer is referred to as being “on,” “connected to” or “coupled to” another element or layer, it can be directly on, connected or coupled to the other element or layer or intervening elements or layers may be present. Like numbers may refer to like elements throughout the specification and drawings.

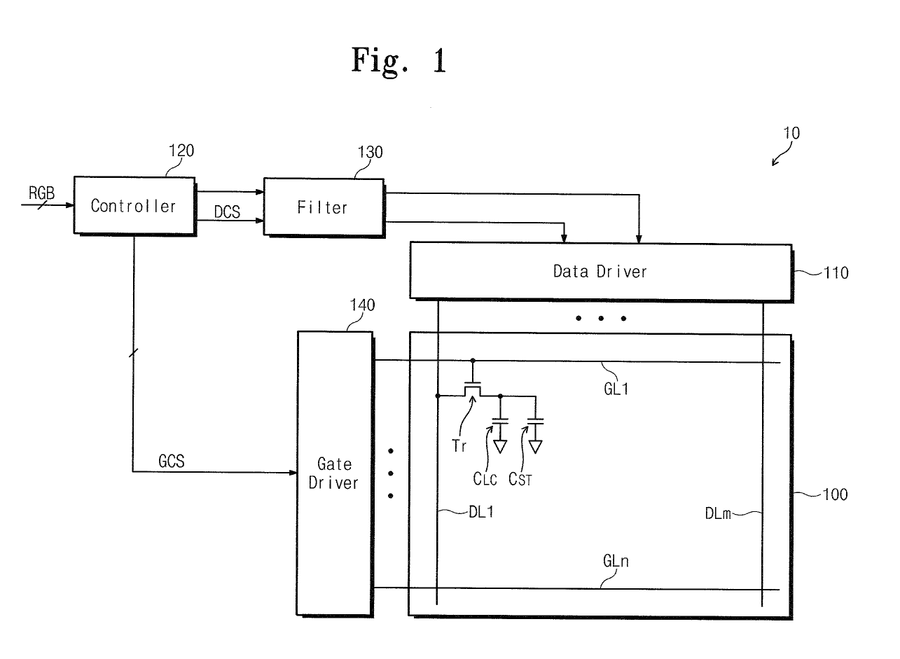

FIG. 1 is a block diagram showing a display apparatus according to an exemplary embodiment of the present invention.

Referring to FIG. 1, a display apparatus 10 includes a display part 100, a data driver 110, a controller 120, a filter 130, and a gate driver 140.

The controller 120 receives image signals RGB from an external device (not shown). The controller 120 converts a data format of the image signals RGB into a data format appropriate to establish an interface between the controller 120 and the data driver 110 and transmits the converted image signals, i.e., a data control signal DCS to the data driver 110 using a differential signaling scheme.

In the present exemplary embodiment, the differential signaling scheme may be a low voltage differential signaling (LVDS), a reduced swing differential signaling (RSDS), or an advanced intra-panel interface (AiPi). In addition, the controller 120 applies a gate signal GCS to the gate driver 140.

In FIG. 1, a circuit configuration has been shown where a pair of signal lines that transmits the data control signal DCS using the differential signaling scheme is placed between the controller 120 and the data driver 110 as an example, but the number of the signal lines connected between the controller 120 and the data driver 110 may be changed in accordance with a size and resolution of a display panel applied to the display part 100. In detail, the signal lines may be connected to each driving integrated circuit (not shown) included in the data driver 110 to transmit the data control signal DCS using the differential signaling scheme.

The display part 100 includes a plurality of gate lines GL1˜GLn, a plurality of data lines DL1˜DLm crossing the gate lines GL1˜GLn, and a plurality of pixels.

Since the pixels have the same structure and function, for the convenience of explanation, one pixel has been shown in detail in FIG. 1. Each of the pixels includes a thin film transistor Tr including a gate electrode connected to a corresponding gate line of the gate lines GL1˜GLn and a source electrode connected to a corresponding data line of the data lines DL1˜DLm, a liquid crystal capacitor C_{LC} connected to a drain electrode of the thin film transistor Tr, and a storage capacitor C_{ST} connected to the drain electrode of the thin film transistor Tr.

When a corresponding gate signal is applied to a selected gate line of the gate lines GL1˜GLn, the thin film transistor Tr connected to the selected gate line is turned on in response to the corresponding gate signal. Thus, a data signal applied to the data line connected to the turned-on thin film transistor Tr is charged in the liquid crystal capacitor C_{LC} and the storage capacitor C_{ST} through the turned-on thin film transistor Tr.

The liquid crystal capacitor C_{LC} controls a light transmittance of a liquid crystal according to the voltage charged therein. The storage capacitor C_{ST} stores the data signal while the thin film transistor Tr is turned-on and applies the stored data signal to the liquid crystal capacitor C_{LC} while the thin film transistor is turned-off Tr, thereby maintaining the liquid crystal capacitor C_{LC} in the charged state. Accordingly, the display part 100 may display an image.

The data driver 110 generates a plurality of gray-scale voltages using gamma voltages provided from a gamma voltage generator (not shown). The data driver 110 selects gray-scale voltages corresponding to the image signals RGB among the gray-scale voltages in response to the data control signal DCS and applies the selected gray-scale voltages to the data lines DL1˜DLm of the display part 100 as data signals. Although not shown in FIG. 1, the data driver 110 may include a plurality of driver integrated circuits.

In addition, although not shown in figures, the display apparatus 10 may further include a backlight unit positioned adjacent to the display part 100 to provide light to the display part 100.

The filter 130 filters the data control signal DCS transmitted to the data driver 110 from the controller 120 in the differential signaling scheme. The filter 130 includes a high-pass filter. Since a display apparatus having a high driving frequency is used to improve image display quality thereof, the data control signal DCS is transmitted at a high frequency from the controller 120 to the data driver 110. Due to the high transmission frequency, the data control signal DCS from the controller 120 is input to the data driver 110 as a signal that has passed through a low-pass filter. Therefore, when the data control signal DCS is filtered by passing through the filter 130 having the high-pass filter, signal distortion caused by the high transmission frequency may be compensated.

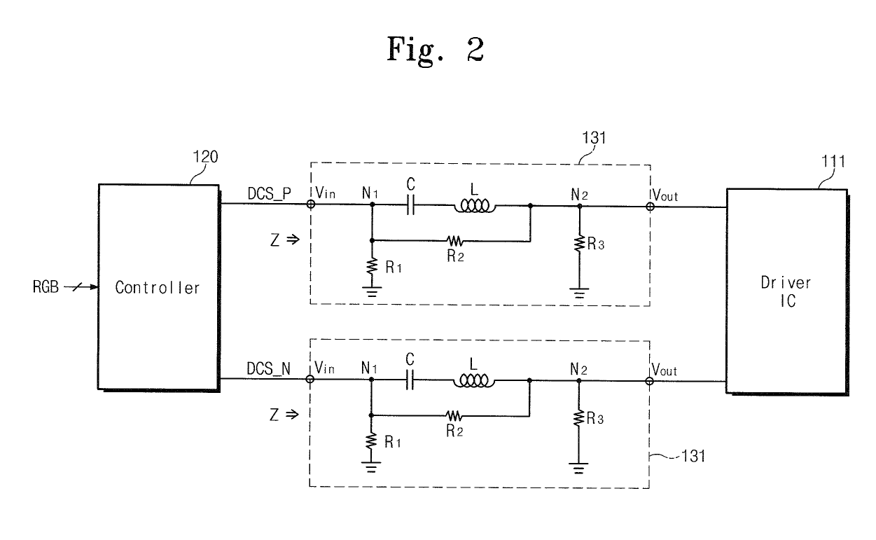

FIG. 2 is a circuit diagram showing a filter of FIG. 1 according to an exemplary embodiment of the present invention. The filter 130 includes a plurality of sub-filters 131 connected to two terminals of one driver IC 111 of the data driver 110 in a one-to-one correspondence to transmit the data control signal DCS using the differential signaling scheme.

Referring to FIG. 2, each driver IC 111 of the data driver 110 is connected to the controller 120 by the pair of signal lines to use the differential signaling scheme, and a pair of data signals DCS_P and DCS_N including positive and negative signals corresponding to the data control signal DCS is applied to the pair of signal lines, respectively.

The sub-filter 131 includes passive elements such as a resistor, a capacitor, and an inductor. The sub-filter 131 shown in FIG. 2 is an example of the high-pass filter, but it is not limited thereto. In other words, the sub-filter 131 may be configured to have active elements with the passive elements.

Referring to FIG. 2, the sub-filter 131 includes a first resistor R₁, a second resistor R₂, a third resistor R₃, a capacitor C, and an inductor L. More particularly, the first resistor R₁ is connected between a first node N₁ and a ground, the second resistor R₂ is connected between the first node N₁ and a second node N₂, the capacitor C and the inductor L are connected to each other in series and connected to the second resistor R₂ in parallel, and the third resistor R₃ is connected between the second node N₂ and the ground.

When assuming that the first node N1 is an input terminal of the sub-filter 131 and the second node N2 is an output terminal of the sub-filter 131, a transfer function H of a transfer voltage ratio that expresses a ratio of an output voltage Vout to an input voltage Vin may be expressed by the following Equation 1.

$$H = \frac{Vout}{Vin} \qquad Equation 1$$

In particular, the transfer function H of the sub-filter 131 may be expressed by a complex frequency (s) as shown by the following Equation 2.

$$\begin{matrix}H = \frac{Vout}{Vin} \\ = \frac{{s}^{2} {LCR}_{3} + {sCR}_{2} {R}_{3} + {R}_{3}}{{s}^{2} LC ( {R}_{2} + {R}_{3} ) + {sCR}_{2} {R}_{3} + {R}_{2} + {R}_{3}}\end{matrix} \qquad Equation 2$$

When substituting “s=jw(w=2πf” into Equation 2 to obtain the characteristic of the transfer function H, the transfer function H may be expressed by the following Equation 3 under conditions of “w” is zero (w=0) and “w” approaches infinity (w→∞).

$$H = \frac{{R}_{3}}{{R}_{2} + {R}_{3}} \qquad Equation 3$$

Except for the above-mentioned two cases, the value of the transfer function H with respect to the other frequencies is smaller than a value obtained from R3/(R2+R3).

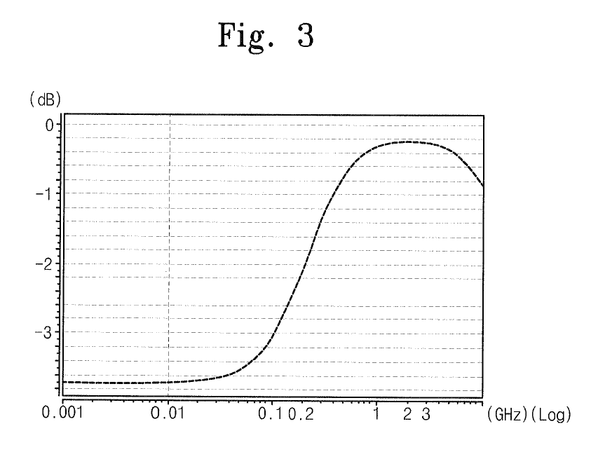

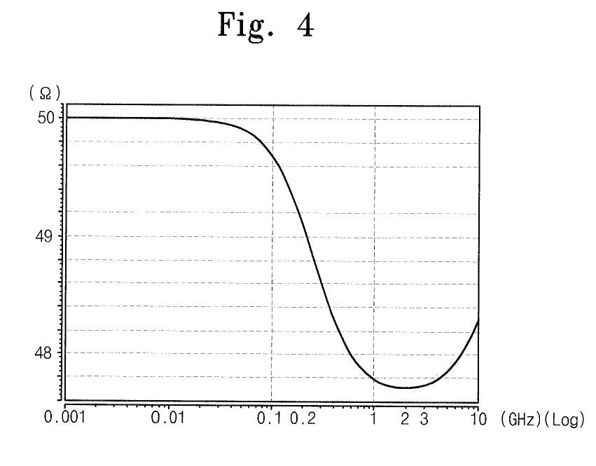

FIG. 3 is a graph showing the transfer voltage ratio of a sub-filter of FIG. 2 as a function of frequency according to an exemplary embodiment of the present invention, and FIG. 4 is a graph showing an input impedance of a sub-filter of FIG. 2 as a function of frequency according to an exemplary embodiment of the present invention.

In FIG. 3, a horizontal axis indicates a frequency GHz on a log scale and a vertical axis indicates a decibel range dB. In FIG. 4, a horizontal axis indicates a frequency GHz on a log scale and a vertical axis indicates an impedance Ω.

As shown in FIG. 3, the transfer function H representing the transfer voltage ratio increases according to an increase in the frequency of the signal applied to the input terminal of the sub-filter 131. Referring to FIG. 3, the sub-filter 131 has the properties of a high-pass filter in a wide range of frequencies (up to 3 GHz).

Meanwhile, impedance matching is required to reduce signal reflections and reduce signal loss while transmitting the data control signal DCS from the controller 120 to the data driver 110 using differential signals.

In the present exemplary embodiment, the input impedance Z of the sub-filter 131 viewed from the input terminal (i.e., the first node N₁) of the sub-filter 131 has a value of about 50 ohms in the frequency spectrum of the transmitted signal.

According to the present exemplary embodiment, the input impedance Z is expressed by the following Equation 4.

$$Z = \frac{{s}^{2} {LCR}_{1} ( {R}_{2} + {R}_{3} ) + {sCR}_{1} {R}_{2} {R}_{3} + {R}_{1} ( {R}_{2} + {R}_{3} )}{\begin{matrix}{s}^{2} LC ( {R}_{1} + {R}_{2} + {R}_{3} ) + \\ {sCR}_{2} ( {R}_{1} + {R}_{3} ) + {R}_{1} + {R}_{2} + {R}_{3}\end{matrix}} \qquad Equation 4$$

When substituting “s=jw” into Equation 4 to obtain the characteristic of the input impedance Z according to the frequency, the input impedance Z converged under conditions of “w” is zero (w=0) (i.e., a DC state) and “w” approaches infinity (w→∞) (i.e., a high-frequency state) may be expressed by the following Equation 5.

$$Z = \frac{{R}_{1} ( {R}_{2} + {R}_{3} )}{{R}_{1} + {R}_{2} + {R}_{3}} \qquad Equation 5$$

When assuming that the converged value of the input impedance Z is about 50 ohms, the input impedance Z may be maintained at about 50 ohms in the range of about 1 GHz to about 3 GHz, which is the transmission frequency of the data control signal DCS, when the first resistor R₁, the second resistor R₂, the third resistor R₃, the capacitor C, and the inductor L have values of about 55 ohms, about 190 ohms, about 360 ohms, about 5 pF, and about 1.2 nH, respectively.

In FIGS. 3 and 4, the transfer function H and the input impedance Z according to the frequency have been shown when the first resistor R₁, the second resistor R₂, the third resistor R₃, the capacitor C, and the inductor L have the above-mentioned values, but they are not limited thereto. In other words, the values of the first resistor R₁, the second resistor R₂, the third resistor R₃, the capacitor C, and the inductor L may be changed if the input impedance Z has a value of about 50 ohms.

As described above, exemplary embodiments of the present invention provide a signal transmission device and a display apparatus having the signal transmission device. The signal transmission device is capable of transmitting data, such as an image signal, without signal distortion and signal loss. This is effectuated through use of a filter that has properties of a high pass filter, the filter being connected to a transmission line that has properties of a low pass filter when high frequency signals are passed therethrough.

Although the exemplary embodiments of the present invention have been described, it is understood that the present invention should not be limited to these exemplary embodiments but various changes and modifications can be made by one of ordinary skill in the art within the spirit and scope of the present invention as hereinafter claimed.

What is claimed is:

1. A display apparatus, comprising:
a display part including a plurality of data lines to display an image;
a data driver electrically connected to the data lines to apply data signals to the data lines;
a controller converting an input image signal into a data format used by the data driver and transmitting the converted image signal to the data driver using a differential signaling scheme; and
a filter filtering the converted image signal provided from the controller in the differential signaling scheme and passing the filtered image signal to the data driver.

2. The display apparatus of claim 1, wherein the differential signaling scheme is a low voltage differential signaling, a reduced swing differential signaling, or an advance intra-panel interface.

3. The display apparatus of claim 2, wherein the filter comprises a high-pass filter.

4. The display apparatus of claim 3, wherein the filter comprises a resistor, a capacitor, and an inductor.

5. The display apparatus of claim 3, wherein the filter has an impedance matching structure.

6. The display apparatus of claim 3, wherein the filter comprises a first resistor connected between a ground and a first node, a second resistor connected between the first node and a second node, a capacitor connected to the second resistor in parallel, an inductor connected to the second resistor in parallel and connected to the capacitor in series, and a third resistor connected between the second node and the ground.

7. A display apparatus, comprising:
a controller that receives a signal from an exterior and outputs an image signal in response to the received signal;
a data driver that outputs a data signal in response to the image signal;
a display part that receives the data signal to display an image; and
a filter disposed between the controller and the data driver to filter the image signal.

8. The display apparatus of claim 7, wherein the controller transmits the image signal to the data driver in a differential signaling scheme.

9. The display apparatus of claim 8, wherein the data driver comprises a plurality of driver integrated circuits.

10. The display apparatus of claim 9, wherein the filter comprises a plurality of sub-filters.

11. The display apparatus of claim 10, wherein each of the driver integrated circuits comprises two input terminals, each input terminal connected to a sub-filter.

12. The display apparatus of claim 11, wherein each of the sub-filters is a high-pass filter having an input impedance of about 50 ohms at a frequency that is the same as a transmission frequency of the image signal.

13. The display apparatus of claim 10, wherein each of the sub-filters comprises:
a first resistor connected between an input terminal and a ground;
a second resistor connected between the input terminal and an output terminal;
a third resistor connected between the output terminal and the ground;
a capacitor connected between the input terminal and the output terminal and connected to the second resistor in parallel; and
an inductor connected between the input terminal and the output terminal and connected to the second resistor in parallel.

14. A signal transmission device, comprising:
a controller that receives a signal from an exterior and outputs an image signal in response to the received signal;
a data driver that receives the image signal; and
a filter disposed between the controller and the data driver to filter the image signal.

15. The signal transmission device of claim 14, wherein the controller transmits the image signal to the data driver in a differential signaling scheme.

16. The signal transmission device of claim 15, wherein the data driver comprises a plurality of driver integrated circuits.

17. The signal transmission device of claim 16, wherein the filter comprises a plurality of sub-filters.

18. The signal transmission device of claim 17, wherein each of the driver integrated circuits comprises two input terminals, each input terminal connected to a sub-filter.

19. The signal transmission device of claim 18, wherein each of the sub-filters is a high-pass filter having an input impedance of about 50 ohms at a frequency that is the same as a transmission frequency of the image signal.

20. The signal transmission device of claim 17, wherein each of the sub-filters comprises:
a first resistor connected between an input terminal and a ground;
a second resistor connected between the input terminal and an output terminal;
a third resistor connected between the output terminal and the ground;
a capacitor connected between the input terminal and the output terminal and connected to the second resistor in parallel; and
an inductor connected between the input terminal and the output terminal and connected to the second resistor in parallel.
